(19) United States
(12) Patent Application Publication
(10) Pub. No.: US 2024/0265934 A1
(43) Pub. Date: Aug. 8, 2024

(54) INFORMATION PROCESSING APPARATUS, SIGNAL PROCESSING APPARATUS, INFORMATION PROCESSING METHOD, AND PROGRAM

(71) Applicant: Sony Group Corporation, Tokyo (JP)

(72) Inventors: Yuichiro KOYAMA, Tokyo (JP); Michael HENTSCHEL, Tokyo (JP); Kan KURODA, Tokyo (JP); Masanobu NAKAMURA, Tokyo (JP); Hiroaki OGAWA, Tokyo (JP); Kentaro SHIBATA, Tokyo (JP); Takashi SHIBUYA, Tokyo (JP); Noriko TOTSUKA, Tokyo (JP); Emiru TSUNOO, Tokyo (JP); Toshimitsu UESAKA, Tokyo (JP); Keiichi YAMADA, Tokyo (JP)

(73) Assignee: Sony Group Corporation, Tokyo (JP)

(21) Appl. No.: 18/563,940

(22) PCT Filed: Feb. 17, 2022
(86) PCT No.: PCT/JP2022/006350

§ 371 Date: Nov. 24, 2023

(30) Foreign Application Priority Data
Jun. 4, 2021 (JP) 2021-094386

(51) Int. Cl. G10L 21/10; G10L 21/0308

(52) U.S. Cl. CPC G10L 21/10; G10L 21/0308

(57) ABSTRACT

An information processing apparatus according to an embodiment of the present technology includes a signal processing unit. The signal processing unit extracts, from a plurality of observation signals obtained by a group of microphones, voice signals respectively related to the microphones by machine learning. This allows desired signal output. Moreover, a person on the other end of the line can easily hear the voice of a speaker and cannot hear the voice of other speaker, thereby providing a feeling of security and high confidentiality for users.

### TECHNICAL FIELD

The present technology relates to an information processing apparatus, a signal processing apparatus, an information processing method, and a program that can be applied to signal processing, for example.

### BACKGROUND ART

Patent Literature 1 has described a meeting minutes creation system. The meeting minutes creation system creates a meeting minutes file in such a manner that voice recognition results of each user are recorded in association with a user identifier and a time of speaking and the voice recognition results are arranged in a speaking order. This system can create meeting minutes in a meeting, for example, (specification paragraphs [0027] to [0058], FIG. 1, etc. in Patent Literature 1).

### CITATION LIST

### Patent Literature

Patent Literature 1: Japanese Patent Application Laid-open No. 2013-11744

### DISCLOSURE OF INVENTION

### Technical Problem

In such signal processing, it is desirable to provide a technology capable of achieving desired signal output.

In view of the above-mentioned circumstances, it is an object of the present technology to provide an information processing apparatus, a signal processing apparatus, an information processing method, and a program capable of achieving desired signal output.

### Solution to Problem

In order to accomplish the above-mentioned object, an information processing apparatus according to an embodiment of the present technology includes a signal processing unit.

The signal processing unit extracts, from a plurality of observation signals obtained by a group of microphones, voice signals respectively related to the microphones by machine learning.

In this information processing apparatus, the voice signals respectively related to the microphones are extracted from the plurality of observation signals obtained by the group of microphones by machine learning. This allows desired signal output.

The group of microphones may include a first microphone. In this case, the observation signals may include a group of voice signals of a group of users including a first user and a noise signal of an environment of the group of users. The signal processing unit outputs a voice signal of the first user from the observation signal obtained by the first microphone.

The information processing apparatus may further include a generation unit that generates learning data used for the machine learning.

The generation unit may generate the learning data on the basis of at least one of the group of voice signals, the noise signal, user information, or environment information related to the environment.

The noise signal may also include a voice signal of a speaker other than the group of users.

The machine learning may use an observation signal when the first microphone has obtained only a voice signal of the first user, as training data.

The information processing apparatus may further include an estimation unit that estimates the voice signals obtained by the microphones from a group of observation signals including the group of voice signals.

The estimation unit may estimate voice signals of the users on the basis of the group of voice signals divided into predetermined time durations.

The estimation unit may estimate voice signals of the users on the basis of the number of microphones of the group of microphones and the number of users of the group of users.

The estimation unit may select microphones that have obtained observation signals with higher amplitudes from the microphones that have obtained the plurality of observation signals and estimate voice signals of the users in a case where the number of microphones of the group of microphones actually used is larger than the number of microphones of the group of microphones estimated when generating the learning data.

The information processing apparatus may further include a presentation unit that presents the extracted voice signals.

The presentation unit may present a graphical user interface that enables the observation signal to be visually recognized.

The group of microphones may have priority information associated with each of the microphones. In this case, the signal processing unit may extract the voice signals on the basis of the priority information.

The information processing apparatus may further include a presentation unit that presents the extracted voice signals. In this case, the presentation unit may present a graphical user interface that displays the voice signal extracted from the observation signal obtained by the microphone with the high priority information.

A signal processing apparatus according to an embodiment of the present technology includes an input unit, a signal processing unit, an output unit, and a presentation unit.

The input unit inputs a plurality of observation signals obtained by a group of microphones.

The signal processing unit extracts each voice signal related to each of microphones from the observation signals by machine learning.

The output unit outputs the voice signals to another device.

The presentation unit presents a graphical user interface that enables the observation signals and the voice signals to be visually recognized.

An information processing method according to an embodiment of the present technology is an information processing method executed by the computer system and including extracting, from a plurality of observation signals obtained by a group of microphones, voice signals respectively related to the microphones by machine learning.

A program according to an embodiment of the present technology causes a computer system to execute the following step.

A step of extracting, from a plurality of observation signals obtained by a group of microphones, voice signals respectively related to the microphones by machine learning.

### BRIEF DESCRIPTION OF DRAWINGS

FIG. 1 A view showing the overview of an information processing apparatus.

FIG. 2 A block diagram showing a configuration of the information processing apparatus.

FIG. 3 A diagram showing DNN learning.

FIG. 4 A schematic view showing inference by the learned DNN.

FIG. 5 A schematic view showing the outer appearance of a signal processing apparatus.

FIG. 6 A schematic view of a signal processing system.

FIG. 7 A block diagram showing a configuration of the information processing apparatus.

FIG. 8 A block diagram showing a hardware configuration example of the information processing apparatus.

### MODE(S) FOR CARRYING OUT THE INVENTION

Hereinafter, an embodiment according to the present technology will be described with reference to the drawings.

### [Information Processing Apparatus]

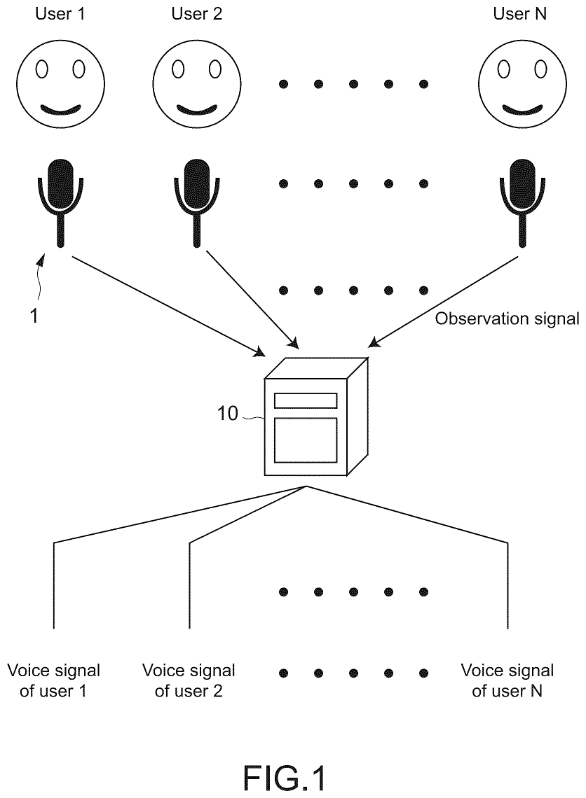

FIG. 1 is a view showing the overview of an information processing apparatus 10 according to the present technology.

As shown in FIG. 1, the information processing apparatus 10 receives the input of observation signals obtained by microphones 1 and extracts a voice signal of each of a group of users (users 1 to N, N denotes any integer) from the observation signals.

The microphones 1 obtains observation signals. The observation signals are signals of sounds obtained by the microphones 1. In the present embodiment, the observation signals include voice signals of the respective users and noise signals of an environment of the group of users. For example, the voice signals are user conversation and conversation contents in a call or meeting, for example.

The voice signals are signals of the voices of the respective users. That is, a voice signal of a user 1 refers to the voice of the user 1. Thus, extracting a voice signal of the user 1 means obtaining a voice signal as if only the user 1 was speaking, and it is a state in which the voice or speaking dialogue of the user 1 is easy to be listened to.

The noise signals include sound signals other than the voice signals of the users. The noise signals are various sounds such as keyboard typing sounds, driving sounds of machines, e.g., cleaner and personal computer, and sounds of animals, e.g., birds and cats.

Moreover, in the present embodiment, each user is located at a short distance, for example, at a position in the same room. That is, a microphone 1 used by the user 1 also obtains a group of voice signals of the users 2 and N, for example, other than the user 1. For example, in a case where the users 1 and 2 located in the same room make meetings with different people, the different people can hear voices of the users who are not related to their meetings.

The information processing apparatus 10 extracts voice signals of the respective users from observation signals including a group of voice signals and noise signals. In the present embodiment, the information processing apparatus 10 extracts voice signals of the respective users by using a deep neural network (DNN).

It should be noted that the number of microphones does not need to equal the number of users. Moreover, a person other than the users using the microphones will be referred to as other speaker. In the present invention, that the user is using the microphone means that the microphone is present at a certain distance or less from a point (mouth area) where the user utters a voice. That is, the observation signals can include voice signals of the other speaker and these voice signals belong to the noise signals.

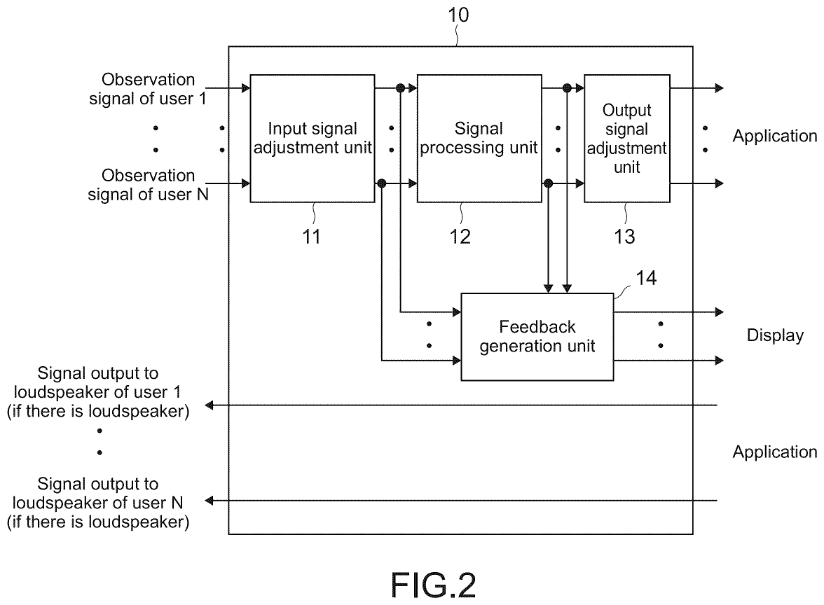

FIG. 2 is a block diagram showing a configuration of the information processing apparatus 10.

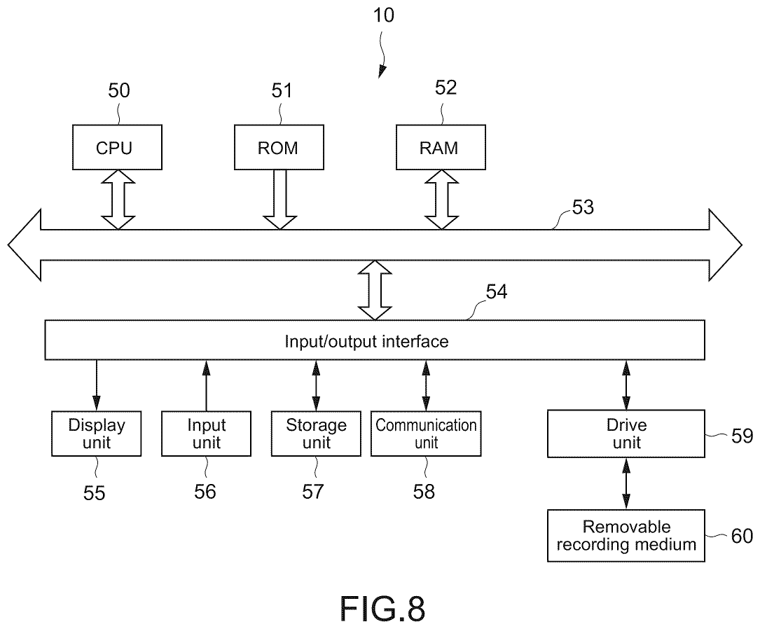

The information processing apparatus 10 has hardware required for a computer configuration, e.g., a processor such as CPU, GPU, DSP, a memory such as ROM and RAM, and a storage device such as an HDD (see FIG. 8). An information processing method according to the present technology is executed by, for example, the CPU loading a program according to the present technology prestored in the ROM, for example, to the RAM and executing it.

For example, any computer such as a PC can achieve the information processing apparatus 10. As a matter of course, hardware such as FPGA and ASIC may be used.

In the present embodiment, a signal processing unit as a functional block is configured by the CPU executing a predetermined program. As a matter of course, dedicated hardware such as an integrated circuit (IC) may be used for achieving the functional blocks.

The information processing apparatus 10 installs the program, for example, via various recording media. Alternatively, the information processing apparatus 10 may install the program, for example, via the Internet.

The type and the like of recording medium on which the program is recorded are not limited, but any computer-readable recording medium may be used. For example, any computer-readable non-transitory storage medium may be used.

As shown in FIG. 2, the information processing apparatus 10 includes an input signal adjustment unit 11, a signal processing unit 12, an output signal adjustment unit 13, and a feedback generation unit 14.

The input signal adjustment unit 11 obtains observation signals obtained by the group of microphones. In the present embodiment, the input signal adjustment unit 11 converts the observation signals into common specifications in a case where the users use microphones with different specifications. For example, the input signal adjustment unit 11 converts the specifications of the observation signals to be digital or analog and have a sampling frequency, a quantization bit rate, and the like.

Moreover, in the present embodiment, the converted observation signals are supplied to the signal processing unit 12 and the feedback generation unit 14.

The signal processing unit 12 extracts voice signals of the respective users from input observation signals by using the DNN. In the present embodiment, learning data generation and DNN learning are performed in advance and the learned DNN is installed in the signal processing unit 12.

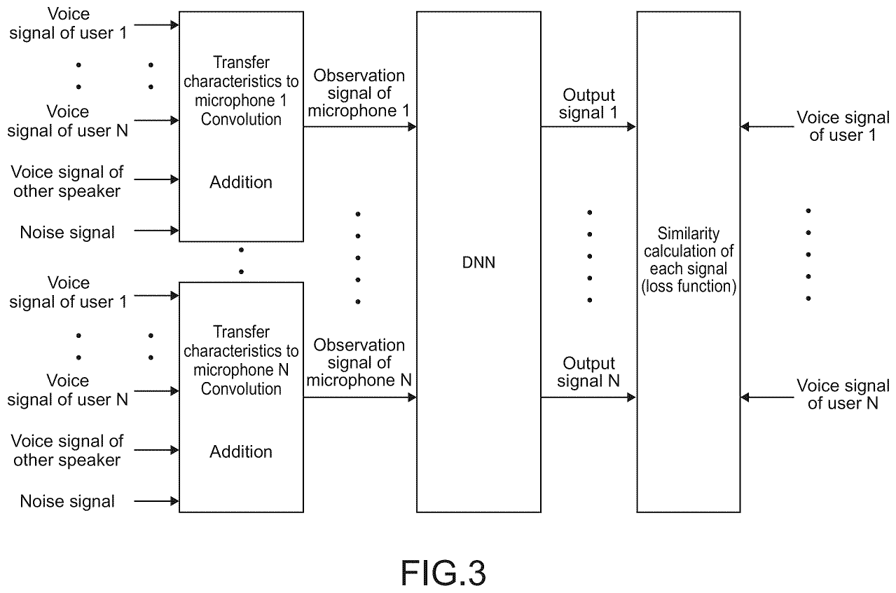

Moreover, the signal processing unit 12 may generate learning data used for the DNN (see FIG. 3). For example, observation signals when the microphone used by the user 1 has obtained only voice signals of the user 1 may be used as training data for the machine learning.

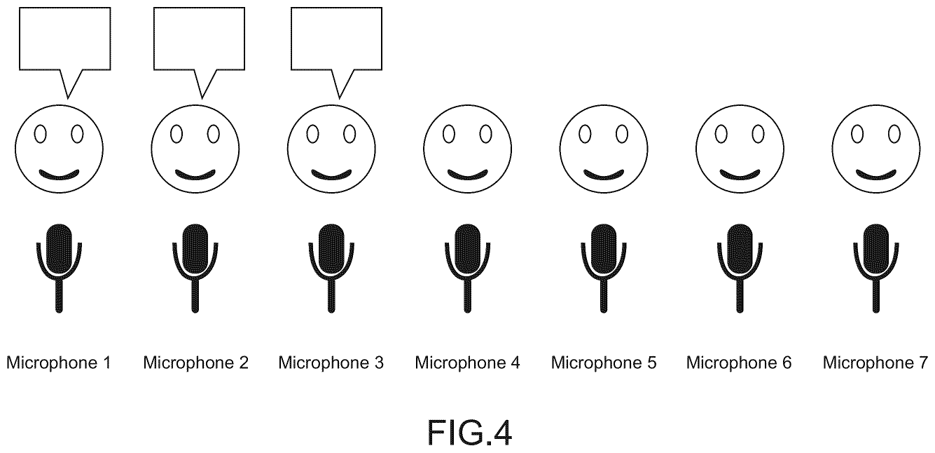

Moreover, a learned model generated with such learning data and training data extracts voice signals in such a manner that the observation signals are divided into constant time durations and the divided observation signals are repeatedly inputted. A specific processing method will be described later with reference to FIG. 4.

Moreover, in the present embodiment, the extracted voice signals of the respective users are supplied to the output signal adjustment unit 13 and the feedback generation unit 14.

The output signal adjustment unit 13 restore the specifications of the microphone converted by the input signal adjustment unit 11 to the original specifications.

The extracted voice signals are supplied to an application. For example, in a case where the application allows a remote meeting via a network, a person talking to the user can more easily hear the voice of the user.

Moreover, the application supplies output signals to an output device such as a loudspeaker of the user. For example, voice signals of an attendee in a remote meeting are output through the loudspeaker.

The feedback generation unit 14 presents input observation signals and extracted voice signals. In the present embodiment, the feedback generation unit 14 displays a GUI on a display device such as a display, which enables the observation signals input to the respective microphones and the voice signals of the respective users to be visually recognized. For example, binary number representation that lights up when the voice signal is equal to or higher than a predetermined sound volume, a meter, spectrum, or waveform indicating the sound volume, or the like is displayed as the GUI.

Moreover, the feedback generation unit 14 notifies the user of an abnormality in the microphone. In the present embodiment, the feedback generation unit 14 determines that the microphone malfunctions in a case where the extracted voice signal is equal to or lower than a constant sound volume for a predetermined time and notifies the user of an abnormality in the microphone.

For example, possible situations in a case where the voice signal is equal to or lower than the constant sound volume for a predetermined time are as follows: a situation where the user's microphone is turned off or malfunctions; a situation where although the user is speaking, the signal processing unit 12 cannot recognize the voice of the user because the user's microphone is too far from the user's mouth so that no signals can be obtained; and a situation where the user are not speaking.

In those situations, the feedback generation unit 14 outputs a text message or voice to the user in order to make the user check that the microphone works correctly or the microphone is not too far from the mouth.

It should be noted that the extracted voice signals may be recorded, for example, rather than being supplied to the application or display. For example, the extracted voice signals may be sent to the user's smartphone, for example, so that the user can check that the extracted voice signals are only his/her voices. Moreover, in a case where the user uses a headset combining a microphone and a loudspeaker, the extracted voice signals may be output to the loudspeaker.

It should be noted that in the present embodiment, the signal processing unit 12 corresponds to a signal processing unit that extracts, from a plurality of observation signals obtained by a group of microphones, voice signals respectively related to the microphones by machine learning.

It should be noted that in the present embodiment, the feedback generation unit 14 corresponds to a presentation unit that presents the extracted voice signals.

FIG. 3 is a diagram showing DNN learning.

In the present embodiment, learning data is generated by simulation. As shown in FIG. 3, N-users use N-microphones, respectively, and voice signals of the respective users are input to each microphone. Moreover, voice signals of one or more other speakers using no microphones are input. Moreover, various noise signals are input.

Voice signals and noise signals to be input are each independently randomly generated with respect to the following environment information (variable).

Size and shape of a room where the users are located.

Coordinates of the mouth areas of the users.

Coordinates of the microphones.

Coordinates of the mouth areas of the other speakers.

Coordinates of sound sources that cause the noise signals.

Voice signals generated from the mouth areas of the users and the other speakers.

Types of noise that cause the noise signals.

Examples of the environment information are not limited to those described above, but learning data may be generated by simulation considering various conditions.

Observation signals obtained by the microphones under each of those conditions are simulated. For example, the simulation uses impulse response obtained by a method of image charges, for example.

Moreover, as to output signals 1 to N output from the DNN, the voice signal of the user 1 to the voice signal of the user N are used as training data as shown in FIG. 3. The output signal 1 is a signal estimated to be the voice signal of the user 1 obtained by the microphone 1. Also, the output signal N is a signal estimated to be the voice signal of the user N obtained by the microphone N.

Similarity between each output signal and the voice signal of each user as the training data is calculated by using a loss function, for example. The DNN is learned so that this similarity increases. Repeating learning under each of the various conditions described above can increase the accuracy of extracting voice signals of the respective users.

FIG. 4 is a schematic view showing inference by the learned DNN.

FIG. 4 shows a case where the number of used microphones is different from the number of microphones (the number of users using the microphones) estimated by the above-mentioned simulation as an example. For example, N denotes the number of microphones estimated by the simulation and N′ denotes the number of microphones actually used. In a case where N=N′, voice signals are extracted in such a manner that the observation signals are divided into constant time durations and the divided observation signals are repeatedly input.

In a case where N>N′, inputting observation signals less than the estimated number as zero signals allows voice signals to be extracted by processing similar to that in a case where N=N′.

In a case where N<N′, (N−1) microphones are selected in order from the microphone that has obtained the observation signal with the highest amplitude (power) in the constant time durations of the observation signals. The remaining microphones are sequentially selected one by one and input to the DNN together with the selected (N−1) microphones. High performance processing can be thus performed. That is, higher performance processing can be performed in a case where the input to the DNN includes a microphone that has obtained the voice signal of the user emitting a voice.

For example, in FIG. 4, a situation where the number of microphones estimated by the simulation is 4 (N=4) and the number of microphones actually used is 7 (N′=7) is shown.

As shown in FIG. 4, there are seven users and users using microphones 1, 2, and 3 emit voices simultaneously. In this case, the microphones 1, 2, and 3 are selected by selecting (N−1), i.e., three microphones in order from the microphone that has obtained the observation signal with the highest amplitude among the observation signals in the constant time durations of the observation signals. Observation signals of a set of the microphones 1, 2, 3, and 4, a set of the microphones 1, 2, 3, and 5, a set of the microphones 1, 2, 3, and 6, and a set of the microphones 1, 2, 3, and 7 are input to the DNN in order and respective voice signals are output.

That is, it is better to input the observation signals of the set of the microphones 1, 2, 3, and 7 to the DNN than to the input observation signals of the set of the microphones 4, 5, 6, and 7 to the DNN, for example, in order to increase the accuracy of extracting a voice signal obtained by the microphone 7 (voice of the user using the microphone 7).

This can improve the performance of the voice signals. Moreover, in a case where any user is wished to use the information processing apparatus 10 at a site depending on a situation, it can be addressed by using the information processing apparatus 10 without preparing systems corresponding to the number of users. Thus, a process from development to introduction can be smooth.

### [Signal Processing Apparatus]

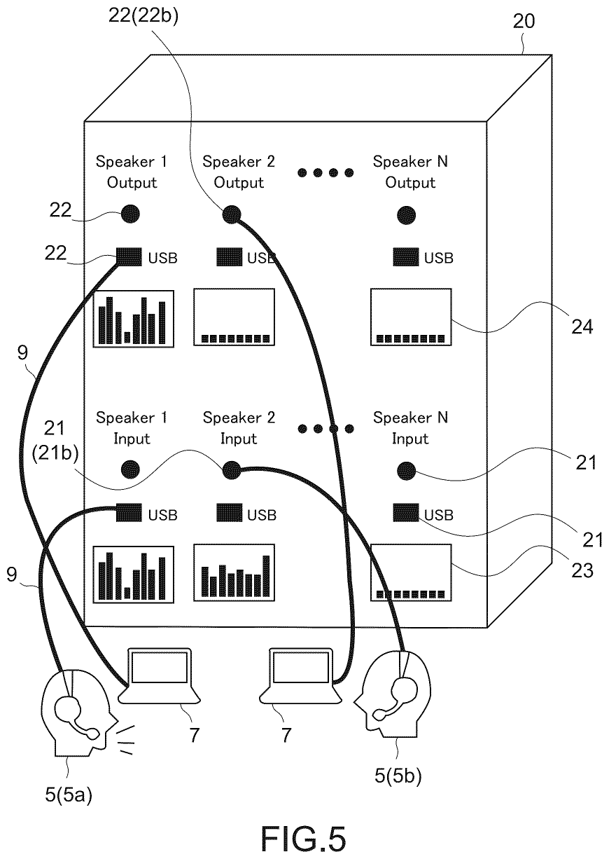

FIG. 5 is a schematic view showing the outer appearance of the signal processing apparatus.

A signal processing apparatus 20 includes the information processing apparatus 10 shown in FIG. 2 and extracts, from a plurality of observation signals obtained by a group of microphones, voice signals respectively related to the microphones.

As shown in FIG. 5, the signal processing apparatus 20 includes an input unit 21, an output unit 22, and a display unit 23.

The input unit 21 is a terminal that receives the input of observation signals. For example, the input unit 21 is connected to a headset combining a microphone and a loudspeaker used by the user 5.

The output unit 22 is a terminal that outputs voice signals. In the present embodiment, the output unit 22 is connected to a personal computer 7 used by the user 5. The user 5 uses the personal computer 7 for executing a desired application such as a remote meeting tool. The user 5 is able to send voice signals of the user 5 to the application through the personal computer 7 connected to the signal processing apparatus 20.

Any number of input units 21 and any number of output units 22 are arranged in the signal processing apparatus 20. In FIG. 5, terminals that are N-input units 21 and N-output units 22 are arranged. A connection method for the input unit 21 to the output unit 22 is not limited, and the input unit 21 to the output unit 22 may be connected to the signal processing apparatus 20 by, for example, digital or analog connection with cables 9 or Bluetooth (registered trademark).

The display unit displays observation signals and voice signals. In the present embodiment, the display unit corresponds to the number of input units 21 and the number of output units 22 and observation signal display units 23 that display observation signals input to the input unit 21 and voice signal display units 24 that display voice signals output from the output units 22 are arranged. In FIG. 5, the observation signal display units 23 and the voice signal display units 24 display spectrums of observation signals and voice signals. The display unit is not limited to the displays, but may be binary number representation with LEDs.

FIG. 5 shows a case where a user 5a is speaking loudly. That is, the microphone of a user 5b obtains voice signals of the user 5a as shown in the observation signal display unit 23. The signal processing apparatus 20 estimates that observation signals input to an input unit 21b are voice signals of the user 5a by using the DNN and prevents the voice signals of the user 5a from being output to an output unit 22b. Moreover, the user 5b can make sure that a person that the user 5b is talking with cannot hear the voice signals of the user 5a by checking the voice signal display unit 24.

With an edge device such as the signal processing apparatus 20, the user can feel security in terms of privacy because his/her voice is processed without being uploaded to a cloud, for example.

### [Signal Processing System]

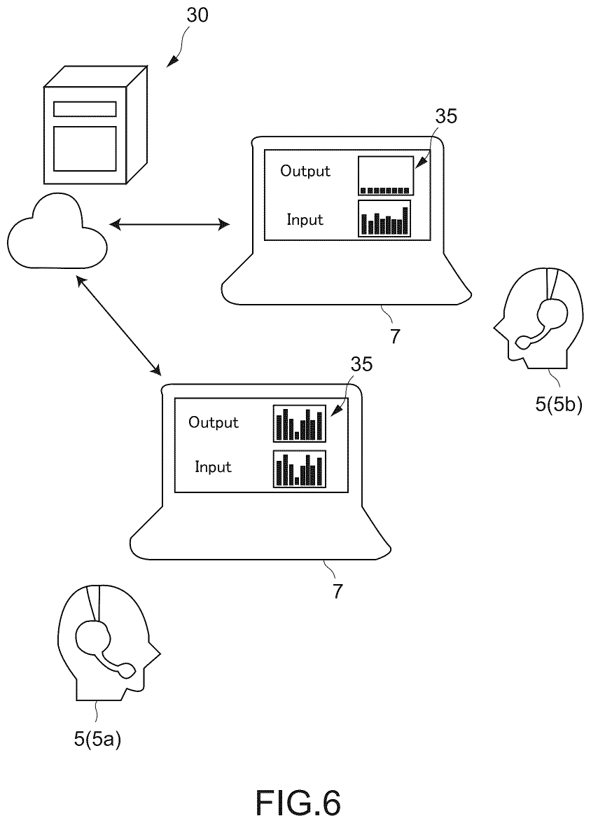

FIG. 6 is a schematic view of a signal processing system.

A signal processing system 30 is a cloud service constituted by a plurality of network hosts and a plurality of servers. For example, the user 5 accesses the signal processing system 30 via the personal computer 7, thereby extracting, from a plurality of observation signals obtained by a group of microphones, voice signals respectively related to the microphones.

In FIG. 6, the users 5a and 5b are located in the same room, for example, in an area where they can hear the other's voice. The user 5 connects his/her microphone to the personal computer 7 that executes an application such as a remote meeting tool (hereinafter, referred to as a meeting application). Moreover, the user 5 executes an application (hereinafter, referred to as a signal processing application) for simultaneously sending and receiving signals to the signal processing system 30 in the personal computer 7.

Voice signals of the users are extracted from observation signals by the signal processing application, and then the voice signals are sent to the meeting application. Moreover, in FIG. 6, the feedback generation unit 14 displays a GUI 35 that enables the observation signals and the voice signals to be visually recognized to the personal computer 7. This enables the user to know how much the other's voice is cancelled. Moreover, a cloud service like the signal processing system does not require the user to prepare a new additional device. Therefore, a meeting or call can be more comfortable.

Hereinabove, the information processing apparatus 10 according to the present embodiment extracts, from the plurality of observation signals obtained by the group of microphones, the voice signals respectively related to the microphones by the DNN. This allows desired signal output.

Conventionally, processing called beam forming has been typically used as signal processing using a plurality of microphones. The beam forming is signal processing using spatial information. In a situation where a plurality of speakers wears their own microphones, it is difficult to apply the beam forming because positional relationships between the plurality of microphones and positional relationships between the microphones and sound sources change.

In the present technology, the group of microphones obtains signals including voices of the plurality of speakers and noise, assuming the situation where a plurality of speakers wears their own microphones. Voice signals of the respective speakers are extracted from the obtained signals. Accordingly, a person on the other end of the line can easily hear the speaker's voice and cannot hear the other speaker's voice, thereby providing a feeling of security and high confidentiality for users. Moreover, a robust operation can be achieved because voices of people wearing no microphone and noise can be both cancelled.

Collectively processing observation signals of the respective users, which have been conventionally separately processed, allows the use of common information. High-accuracy signal processing can be thus achieved. Moreover, only connecting to the system without the need for previous registration and the like can keep only the microphone wearer's voice, and a remote meeting or call can be done at the same place at the same time. In addition, displaying sound volume and waveforms, for example, of output voice signals allows check of effects of the processing. Therefore, the user can easily know that only his/her voice is output.

### OTHER EMBODIMENTS

The present technology is not limited to the above-mentioned embodiment, and various other embodiments can be achieved.

In the above-mentioned embodiment, the information processing apparatus 10 is used for the remote meeting or call, for example. The present technology is not limited thereto. A show production work flow for a television show, a radio show, or the like may be used.

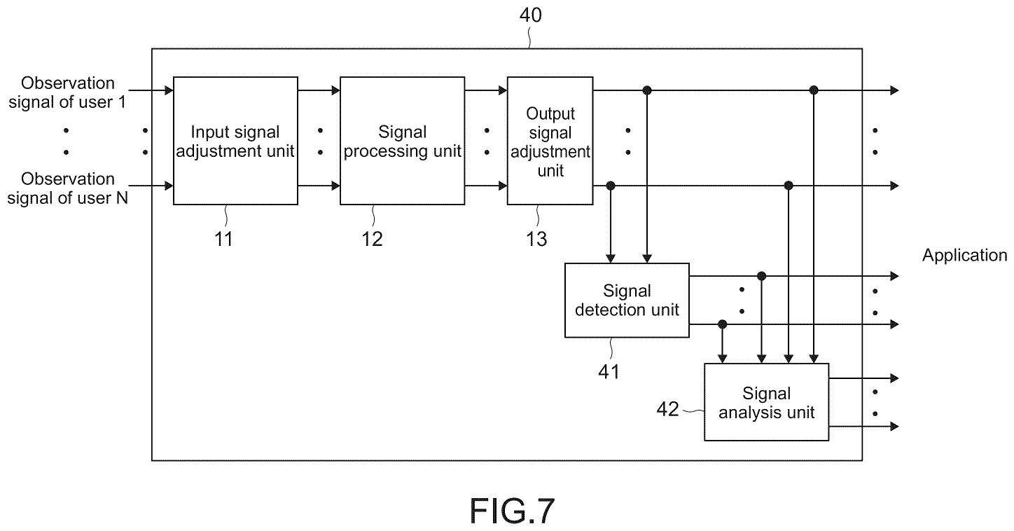

FIG. 7 is a block diagram showing a configuration of an information processing apparatus 40.

As shown in FIG. 7, the information processing apparatus 40 includes a signal detection unit 41 and a signal analysis unit 42 besides the input signal adjustment unit 11, the signal processing unit 12, the output signal adjustment unit 13 shown in FIG. 2.

The signal detection unit 41 detects a particular user's voice with respect to a voice signal per user output from the output signal adjustment unit 13. For example, the signal detection unit 41 determines whether the output voice signal per user includes the voice of the user 1.

Moreover, the signal detection unit 41 detects speech section information including the start time and end time of the voice from each voice signal.

The signal analysis unit 42 analyzes the voice signal of the user. In the present embodiment, the signal analysis unit 42 analyzes the voice signal on the basis of the speech section information and the voice signal. For example, the signal analysis unit 42 performs voice recognition on a speaking dialogue of the user and converts it to a text format (writes it). Accordingly, a word uttered by a wearer (cast member) with each microphone can be automatically written, which can reduce a burden in the show production place.

Moreover, the signal analysis unit 42 identifies feeling expressions such as laugh and angry voice. Accordingly, the number of times and duration when each microphone wearer (cast member) laughed can be counted. Moreover, recording which cast member has uttered a word just before laughs are detected enables a determination as to which cast member has evoked the highest laughs.

Moreover, the signal analysis unit 42 identifies which cast member has emitted the voice, by referring to information about cast members registered in advance. In the present technology, which microphone user has emitted the voice can be estimated, but it cannot be associated with information indicating who the wearer is (actual name (hereinafter, referred to as speaker information)). In view of this, the speaker information is output by the following two methods.

A method of fixedly associating each microphone with the speaker information. In this method, fixed relationships between microphones and speaker information are registered, for example, a fixed relationship between a microphone 1 and a user A and a fixed relationship between a microphone 2 associated with a user B are registered in the system (information processing apparatus 40) and association is performed by referring to such information. That is, it is necessary to register the correlations of the microphones to the speaker information per show and the microphones are not exchanged during show recording as a premise.

A method of estimating the speaker information by speaker identification processing. In this method, the speaker information is estimated by the speaker identification processing. Therefore, the speaker information can be correctly estimated even if the microphones are exchanged during show recording. In the speaker identification processing, optimal speaker information is output from a speaker information database related to cast members registered in advance on the basis of the speech section information output by the signal detection unit 41 and the voice signal output by the signal processing unit 12. This method does not require processes such as registration even if show and cast members are changed as long as the speaker information database includes the cast members.

It should be noted that the signal detection unit 41 and the signal analysis unit 42 can employ any signal processing technologies such as voice activity detection (VAD), voice recognition, detection of laughs and angry voices, and speaker identification. For example, since the signal processing unit 12 extracts voice signals from observation signals including a noise signal, the present technology can be adapted for conventional signal processing technologies.

Moreover, the present technology can also be applied to a cappella, a concert, and the like other than the show production work flow. For example, the present technology can also be applied for extracting a voice signal of the singing voice of each of singers in chorus or a voice signal of the instrument sound of each of instrument players in ensemble.

As to the chorus, it is possible to check whether the singing voice of each singer is out of tone or to record the singing voice of each singer while all singers are singing. For example, voice signals of the respective singers can be extracted by all singers wearing microphones. Moreover, also as to the ensemble, the instrument sound of each player can be obtained by setting a microphone near the instrument of each instrument player.

Moreover, the present technology can also be applied to a meeting where all attendees are located in an ordinary meeting room, not a remote meeting. For example, the meeting participants respectively wear microphones and the voice of each meeting participant is obtained. Moreover, the use of the information processing apparatus 40 allows words uttered by each meeting participant to be converted to a text format and automatically recorded as meeting minutes.

In the above-mentioned embodiment, the spectrums are displayed as the GUIs that enable the observation signals and the voice signals to be visually recognized. The present technology is not limited thereto. Colors may be respectively associated with the users output and each spectrum or waveform may be displayed in the color for each user. Moreover, which user's voice is output may be visually recognized by lighting an LED corresponding to each user who are speaking. Moreover, how much correct (estimation accuracy) a voice signal of the user extracted from an input observation signal is may be displayed in percentage.

In the above-mentioned embodiment, the microphones that have obtained the observation signals are selected in order from the microphone that has obtained the observation signal with the highest power at the time of the inference by the learned DNN. The present technology is not limited thereto. The observation signals may be arbitrarily selected. For example, priority information may be associated with each microphone. For example, a president using the microphone 1 (priority: high), a manager using the microphone 2 (priority: middle), and rank-and-file employees using the microphones 3 to 7 (priority: low) may be set. Moreover, in a case where only one display displays the GUI that enables extracted voice signals to be visually recognized, a voice signal of the user with the highest priority may be preferentially displayed.

FIG. 8 is a block diagram showing hardware configuration examples of the information processing apparatus 10.

The information processing apparatus 10 includes a CPU 50, a ROM 51, a RAM 52, an input/output interface 54, and a bus 53 that connects them to one another. A display unit 55, an input unit 56, a storage unit 57, a communication unit 58, a drive unit 59, and the like are connected to the input/output interface 54.

The display unit 55 is, for example, a display device using liquid crystals, EL, or the like. The input unit 56 is, for example, a keyboard, a pointing device, a touch panel, or another operation device. In a case where the input unit 56 includes a touch panel, the touch panel can be integral with the display unit 55.

The storage unit 57 is a nonvolatile storage device. The storage unit 57 is, for example, an HDD, a flash memory, or another solid-state memory. The drive unit 59 is, for example, a device capable of driving a removable recording medium 60 such as an optical recording medium and a magnetic record tape.

The communication unit 58 is a modem, a router, or another communication device for communicating with other devices, which is connectable to a LAN, a WAN, or the like. The communication unit 58 may perform wired communication or may perform wireless communication. The communication unit 58 is often used separately from the information processing apparatus 10.

In the present embodiment, the communication unit 58 is capable of communicating with other devices via a network.

Cooperation of software stored in the storage unit 57, the ROM 51, or the like with hardware resources of the information processing apparatus 10 achieves information processing of the information processing apparatus 10 having the hardware configurations as described above. Specifically, loading a program that configures the software, which has been stored in the ROM 51 or the like, to the RAM 52 and executing it achieves the control method according to the present technology.

The information processing apparatus 10 installs the program via the recording medium 60, for example. Alternatively, the information processing apparatus 10 may install the program via a global network or the like. Otherwise, any computer-readable non-transitory storage medium may be used.

Cooperation of a computer mounted on a communication terminal with another computer capable of communicating with it via a network or the like may execute the information processing method and the program according to the present technology and configure the information processing unit according to the present technology.

That is, the information processing apparatus, the signal processing apparatus, the information processing method, and the program according to the present technology may be performed not only in a computer system constituted by a single computer but also in a computer system in which a plurality of computers cooperatively operate. It should be noted that in the present disclosure, the system means a set of a plurality of components (e.g., apparatuses, modules (parts)) and it does not matter whether or not all the components are housed in the same casing. Therefore, both of a plurality of apparatuses housed in separate casings and connected to one another via a network and a single apparatus having a plurality of modules housed in a single casing are the system.

Executing the information processing apparatus, the signal processing apparatus, the information processing method, and the program according to the present technology by the computer system includes, for example, both of a case where a single computer executes voice signal extraction, observation signal estimation, learning data generation, and the like and a case where different computers execute the respective processes. Moreover, executing the respective processes by a predetermined computer includes causing another computer to execute some or all of those processes and acquiring the results.

That is, the information processing apparatus, the signal processing apparatus, the information processing method, and the program according to the present technology can also be applied to a cloud computing configuration in which a plurality of apparatuses shares and cooperatively processes a single function via a network.

The respective configurations such as the input signal adjustment unit, the signal processing unit, and the feedback generation unit, the control flow of the communication system, and the like, which have been described with reference to the respective drawings, are merely embodiments, and can be arbitrarily modified without departing from the gist of the present technology. That is, any other configurations, algorithms, and the like for carrying out the present technology may be employed.

It should be noted that the effects described in the present disclosure are merely exemplary and not limitative, and further other effects may be provided. The description of the plurality of effects above does not necessarily mean that those effects are provided at the same time. It means that at least any one of the above-mentioned effects is obtained depending on a condition and the like, and effects not described in the present disclosure can be provided as a matter of course.

At least two features of the features of the above-mentioned embodiments may be combined. That is, the various features described in the respective embodiments may be arbitrarily combined across the respective embodiments.

It should be noted that the present technology can also take the following configurations.

(1) An information processing apparatus, including
a signal processing unit that extracts, from a plurality of observation signals obtained by a group of microphones, voice signals respectively related to the microphones by machine learning.
   (2) The information processing apparatus according to (1), in which
the group of microphones includes a first microphone,
the observation signals include a group of voice signals of a group of users including a first user and a noise signal of an environment of the group of users, and
the signal processing unit outputs a voice signal of the first user from the observation signal obtained by the first microphone.
   (3) The information processing apparatus according to (2), further including
a generation unit that generates learning data used for the machine learning.
   (4) The information processing apparatus according to (3), in which
the generation unit generates the learning data on the basis of at least one of the group of voice signals, the noise signal, user information, or environment information related to the environment.
   (5) The information processing apparatus according to (2), in which
the noise signal also includes a voice signal of a speaker other than the group of users.
   (6) The information processing apparatus according to (2), in which
the machine learning uses an observation signal when the first microphone has obtained only a voice signal of the first user, as training data.
   (7) The information processing apparatus according to (3), further including
an estimation unit that estimates the voice signals obtained by the microphones from a group of observation signals including the group of voice signals.
   (8) The information processing apparatus according to (7), in which
the estimation unit estimates voice signals of the users on the basis of the group of voice signals divided into predetermined time durations.
   (9) The information processing apparatus according to (7), in which
the estimation unit estimates voice signals of the users on the basis of the number of microphones of the group of microphones and the number of users of the group of users.
   (10) The information processing apparatus according to (7), in which
the estimation unit selects microphones that have obtained observation signals with higher amplitudes from the microphones that have obtained the plurality of observation signals and estimates voice signals of the users in a case where the number of microphones of the group of microphones actually used is larger than the number of microphones of the group of microphones estimated when generating the learning data.
   (11) The information processing apparatus according to (1), further including
a presentation unit that presents the extracted voice signals.
   (12) The information processing apparatus according to (11), in which
the presentation unit presents a graphical user interface that enables the observation signal to be visually recognized.
   (13) The information processing apparatus according to (1), in which
the group of microphones has priority information associated with each of the microphones, and
the signal processing unit extracts the voice signals on the basis of the priority information.
   (14) The information processing apparatus according to (13), further including
a presentation unit that presents the extracted voice signals, and
the presentation unit presents a graphical user interface that displays the voice signal extracted from the observation signal obtained by the microphone with the high priority information.
   (15) A signal processing apparatus, including:
an input unit that inputs a plurality of observation signals obtained by a group of microphones;
a signal processing unit that extracts each voice signal related to each of microphones from the observation signals by machine learning;
an output unit that outputs the voice signals to another device; and
a presentation unit that presents a graphical user interface that enables the observation signals and the voice signals to be visually recognized.
   (16) An information processing method, including by a computer system,
extracting, from a plurality of observation signals obtained by a group of microphones, voice signals respectively related to the microphones by machine learning.
   (17) A program that causes a computer system to execute
a step of extracting, from a plurality of observation signals obtained by a group of microphones, voice signals respectively related to the microphones by machine learning.
   (18) An information processing system, including:
a group of microphones; and
an information processing apparatus including
   an input unit that inputs a plurality of observation signals obtained by the group of microphones,
   a display unit,
   a signal processing terminal including an output unit that outputs respective voice signals related to the microphones,
   a signal processing unit that extracts the voice signals from the plurality of observation signals by machine learning, and
   a presentation unit that presents a graphical user interface that enables the observation signals to be visually recognized to the display unit.

### REFERENCE SIGNS LIST

1 microphone
10 information processing apparatus
12 signal processing unit
20 signal processing apparatus
30 signal processing system

1. An information processing apparatus, comprising
a signal processing unit that extracts, from a plurality of observation signals obtained by a group of microphones, voice signals respectively related to the microphones by machine learning.

2. The information processing apparatus according to claim 1, wherein
the group of microphones includes a first microphone,
the observation signals include a group of voice signals of a group of users including a first user and a noise signal of an environment of the group of users, and
the signal processing unit outputs a voice signal of the first user from the observation signal obtained by the first microphone.

3. The information processing apparatus according to claim 2, further comprising
a generation unit that generates learning data used for the machine learning.

4. The information processing apparatus according to claim 3, wherein
the generation unit generates the learning data on a basis of at least one of the group of voice signals, the noise signal, user information, or environment information related to the environment.

5. The information processing apparatus according to claim 2, wherein
the noise signal also includes a voice signal of a speaker other than the group of users.

6. The information processing apparatus according to claim 2, wherein
the machine learning uses an observation signal when the first microphone has obtained only a voice signal of the first user, as training data.

7. The information processing apparatus according to claim 3, further comprising
an estimation unit that estimates the voice signals obtained by the microphones from a group of observation signals including the group of voice signals.

8. The information processing apparatus according to claim 7, wherein
the estimation unit estimates voice signals of the users on a basis of the group of voice signals divided into predetermined time durations.

9. The information processing apparatus according to claim 7, wherein
the estimation unit estimates voice signals of the users on a basis of the number of microphones of the group of microphones and the number of users of the group of users.

10. The information processing apparatus according to claim 7, wherein
the estimation unit selects microphones that have obtained observation signals with higher amplitudes from the microphones that have obtained the plurality of observation signals and estimates voice signals of the users in a case where the number of microphones of the group of microphones actually used is larger than the number of microphones of the group of microphones estimated when generating the learning data.

11. The information processing apparatus according to claim 1, further comprising
a presentation unit that presents the extracted voice signals.

12. The information processing apparatus according to claim 11, wherein
the presentation unit presents a graphical user interface that enables the observation signal to be visually recognized.

13. The information processing apparatus according to claim 1, wherein
the group of microphones has priority information associated with each of the microphones, and
the signal processing unit extracts the voice signals on a basis of the priority information.

14. The information processing apparatus according to claim 13, further comprising
a presentation unit that presents the extracted voice signals, and
the presentation unit presents a graphical user interface that displays the voice signal extracted from the observation signal obtained by the microphone with the high priority information.

15. A signal processing apparatus, comprising:
an input unit that inputs a plurality of observation signals obtained by a group of microphones;
a signal processing unit that extracts each voice signal related to each of microphones from the observation signals by machine learning;
an output unit that outputs the voice signals to another device; and
a presentation unit that presents a graphical user interface that enables the observation signals and the voice signals to be visually recognized.

16. An information processing method, comprising
by a computer system,
extracting, from a plurality of observation signals obtained by a group of microphones, voice signals respectively related to the microphones by machine learning.

17. A program that causes a computer system to execute
a step of extracting, from a plurality of observation signals obtained by a group of microphones, voice signals respectively related to the microphones by machine learning.
